(19) United States
(12) Patent Application Publication
(10) Pub. No.: US 2025/0303783 A1
(43) Pub. Date: Oct. 2, 2025

(54) Three-dimensional Magnetic Spacer for Maintaining Space Between Layers of Art

(71) Applicant: Stephanie Lee Birth, Walkersville, MD (US)

(72) Inventor: Stephanie Lee Birth, Walkersville, MD (US)

(21) Appl. No.: 19/096,058

(22) Filed: Mar. 31, 2025

Related U.S. Application Data
(60) Provisional application No. 63/572,737, filed on Apr. 1, 2024.

(51) Int. Cl. B44C 3/02

(52) U.S. Cl. CPC B44C 3/02

(57) ABSTRACT

A magnetic spacer system comprising multiple identical spacers for maintaining uniform spacing between layers of artwork. Each spacer is made of a flexible yet structurally rigid material, such as corkboard, rubber, or foam, and includes an outer contour and a central cutout of the same shape, with the cutout being a scaled-down version of the outer contour. This structure defines a continuous border of material around the cutout, allowing visibility of lower artwork layers. The spacers are embedded with magnets that allow secure attachment to adjacent spacers without adhesives. A minimum of three spacers is used to separate at least two art layers, enabling the creation of a three-dimensional visual effect. The embedded magnets are fully enclosed to prevent dislodgement, allowing for reliable stacking and easy reconfiguration. The system facilitates fast, repeatable, and non-destructive assembly of layered art while preserving the integrity and reusability of each art layer.

### CROSS-REFERENCE TO RELATED APPLICATIONS

Priority Claim: This application claims the benefit of U.S. Provisional Application No. 63/572,737, filed on Apr. 1, 2024.

### STATEMENT REGARDING FEDERALLY SPONSORED RESEARCH OR DEVELOPMENT

Not Applicable

### REFERENCE TO A SEQUENCE LISTING, A LARGE TABLE, OR A COMPUTER PROGRAM LISTING APPENDIX ON READ-ONLY OPTICAL DISC

Not Applicable

### BACKGROUND OF THE INVENTION

The present invention relates generally to art and craft display systems, and more particularly to reusable magnetic spacer systems designed to maintain uniform spacing between layers of artwork in multi-layered visual compositions.

Layered artwork has become a popular technique among crafters, particularly those who use electronic cutting machines such as Cricut®, Silhouette®, or similar devices to cut intricate designs from SVG files into paper, cardstock, vinyl, or thin acrylic sheets. These materials are often stacked in a specific sequence to create a dimensional scene, typically displayed in shadow boxes, on lighted bases, or as freestanding artwork.

Existing techniques for creating depth between layers involve using paper spacers, foamboard, or adhesive foam dots. Each of these approaches presents challenges. Paper and foamboard spacers are usually cut to the same shape and size as the art layers, then adhered using double-sided tape or glue, requiring multiple tools and materials such as a cutting machine or knife, ruler, template, spacer material, and adhesives. This makes the process time-consuming and destructive-once adhered, the layers cannot be repositioned or reused. The required adhesives also make it difficult to swap out a single layer or repurpose spacers for a new project. Additionally, these materials often do not retain their shape well, leading to inconsistent separation or sagging.

Adhesive foam dots and squares offer a partial solution but typically require multiple pieces per layer to achieve even spacing. When not used in sufficient quantity or placed inconsistently, they can allow sagging between support points. Even when placed correctly, the adhesive foam is often visible beneath translucent or light-colored artwork layers, especially when backlit or displayed in a lighted shadow box. In contrast, the magnetic spacers of the present invention are placed only around the perimeter, where they are concealed from view, and the magnetic attraction helps hold the art layer taut and evenly spaced without sagging.

The inventor has experimented with placing loose magnets between layers of artwork to achieve separation. However, this method lacked structural consistency and required numerous individual magnet placements to avoid sagging or misalignment. These early experiments demonstrated that magnets alone were insufficient without a shaped, integrated structure to maintain uniform spacing and alignment across multiple layers.

The United States Patent Classification system broadly categorizes display systems and mounting hardware under classes such as Class 40 (Card, Picture, or Sign Exhibiting) and Class 248 (Supports). However, these categories do not adequately address the specific needs of reusable, shape-matched, magnetic spacing systems that support precise, repeatable, and non-destructive assembly of layered visual art.

Accordingly, there remains a need for an improved art and craft spacer system that overcomes one or more of these limitations by providing consistent, reliable spacing without adhesives; allowing for non-destructive reconfiguration; and matching the shape of the layered artwork while maintaining full visibility of the underlying layers.

### BRIEF SUMMARY OF THE INVENTION

The present invention provides a reusable, non-destructive magnetic spacer system for assembling multi-layered visual artwork with uniform spacing between each layer. Each magnetic spacer is composed of a flexible yet shape-retaining material and includes embedded magnets that enable rapid alignment and secure attachment to adjacent spacers without the use of adhesives or fasteners.

The magnetic spacers are shaped to match the outer contour of the artwork and include a central cutout of the same shape, scaled down to preserve visibility of the underlying layers. This structure creates a continuous border of material that maintains consistent spacing while allowing full visibility through the stacked design. The magnets are fully enclosed within each magnetic spacer and are strategically placed to prevent sagging and maintain layer alignment.

This magnetic spacer system addresses common problems found in adhesive-based assembly methods, including irreversible attachment, sagging, misalignment, and difficulty reusing components. It allows for clean, precise, and customizable layering of materials such as paper, cardstock, vinyl, and thin acrylic sheets. The system enables repeatable, tool-free assembly of layered artwork for shadow boxes, lighted displays, or standalone presentation.

An object of the invention is to provide a simple, reusable, and magnetically aligned spacer system that supports consistent, non-destructive assembly of layered visual artwork while preserving visibility and structural integrity across multiple layers.

### BRIEF DESCRIPTION OF THE SEVERAL VIEWS OF THE DRAWING

FIG. 1 is a top view of a magnetic spacer (100) showing the outer contour (102), central cutout (104), spacer body (106), and embedded magnets (108) positioned within the spacer body.

FIG. 2 is a cross-sectional view of an individual magnetic spacer (100), illustrating the spacer body (106) with embedded magnets (108) that are fully enclosed within the material to prevent dislodgement during use and maintain consistent magnetic functionality.

FIG. 3 is an exploded side view of two magnetic spacers (100) separated by an artwork layer (112), illustrating embedded magnets (108) labeled with opposite polarities. The magnets are positioned such that the S-pole of each upper magnet aligns with the N-pole of the corresponding lower magnet, enabling consistent magnetic attraction between adjacent spacers.

FIG. 4 is an enlarged detail view of the magnet alignment from FIG. 3, showing the north (N) and south(S) polarity labels on each magnet (108). The orientation illustrates how the S-pole of the upper spacer magnet is aligned with the N-pole of the lower spacer magnet to ensure consistent magnetic attraction.

FIG. 5 is a perspective view illustrating the non-destructive removal of two magnetic spacers (100) and corresponding artwork layers (112) from an original magnetic spacer system (120). The removed components are shown separate from the system, demonstrating that both the remaining configuration and the removed components remain intact and undamaged.

FIG. 6 is a top view of a custom-shaped artwork layer (112), illustrating a decorative outline that is non-standard in shape and used to demonstrate compatibility with a matching magnetic spacer.

FIG. 7 is a top view of a magnetic spacer (100) cut in a custom shape that matches the artwork layer shown in FIG. 6. The spacer includes an outer contour (102), a central cutout (104), a spacer body (106), and embedded magnets (108).

FIG. 8 is a front-facing perspective view of a magnetic spacer system (120) constructed with thin magnetic spacers, resulting in a reduced overall depth between artwork layers.

FIG. 9 is a front-facing perspective view of a magnetic spacer system (120) using thicker magnetic spacers than those in FIG. 8, producing a greater depth between artwork layers.

### DETAILED DESCRIPTION OF THE INVENTION

The invention will now be described in detail with reference to the accompanying drawings. These drawings illustrate exemplary embodiments of the invention, in which like reference numerals refer to corresponding parts throughout the several views.

The invention relates to a magnetic spacer system designed to maintain uniform spacing between layers of artwork in three-dimensional compositions such as shadow boxes, paper crafts, illuminated displays, or standalone layered artwork. The system consists of reusable, magnetically attachable spacers, each having a defined outer contour and a central cutout, configured to match the shape of the artwork layer it supports.

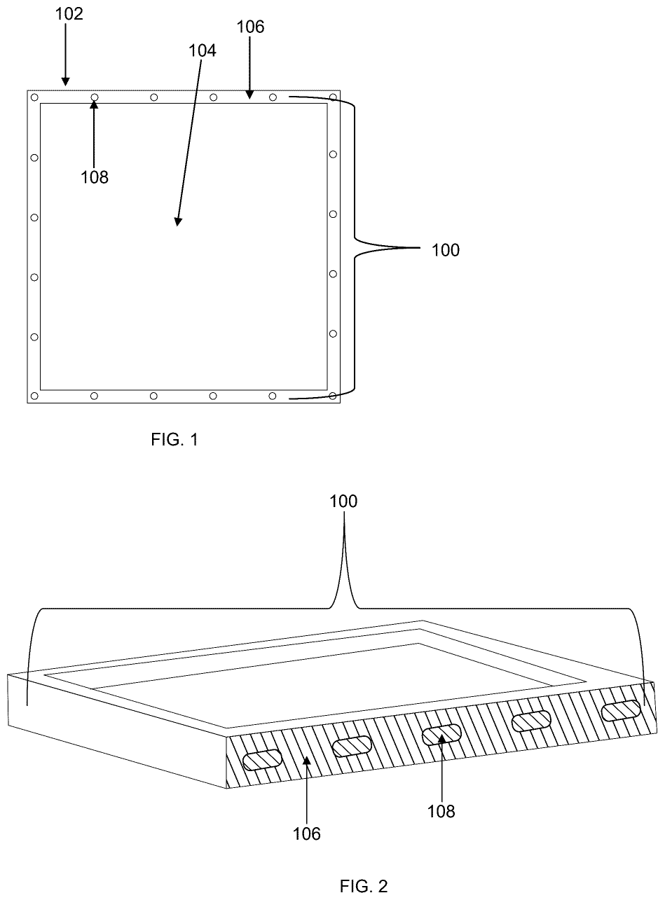

### FIG. 1—Top View of Magnetic Spacer

FIG. 1 illustrates a top view of an individual magnetic spacer (100), which serves as the core component of the magnetic spacer system. The magnetic spacer has an outer contour (102), which defines the external boundary and matches the shape of the artwork layer it supports. A central cutout (104) is formed within the spacer, shaped as a scaled-down version of the outer contour, to allow full visibility of the underlying artwork layers. The material between the outer contour and the cutout forms the spacer body (106), which is composed of a flexible, shape-retaining material such as corkboard, rubber, or foam. Embedded within the spacer body are a plurality of magnets (108), which are fully enclosed and positioned such that each magnet is surrounded by spacer material. This configuration secures the magnets in place and prevents exposure, regardless of the magnet's size or exact position within the spacer body. This placement provides structural stability and ensures uniform magnetic attachment to adjacent spacers in a stacked configuration, without the need for adhesives or mechanical fasteners.

### FIG. 2—Cross-Sectional View of Magnetic Spacer

FIG. 2 provides a cross-sectional view of the magnetic spacer (100) to highlight the internal structure of the spacer body (106) and the placement of the embedded magnets (108). The spacer body is composed of a flexible, shape-retaining material, such as corkboard, rubber, or foam. Each magnet (108) is fully enclosed within the spacer body and surrounded by spacer material on all sides, ensuring that no part of the magnet is exposed. This configuration prevents the magnets from becoming dislodged during normal use and allows for reliable, tool-free magnetic attachment and reattachment between adjacent spacers. This design maintains the intended function of the magnetic spacer system while preserving the integrity of the artwork layers during repeated assembly and disassembly.

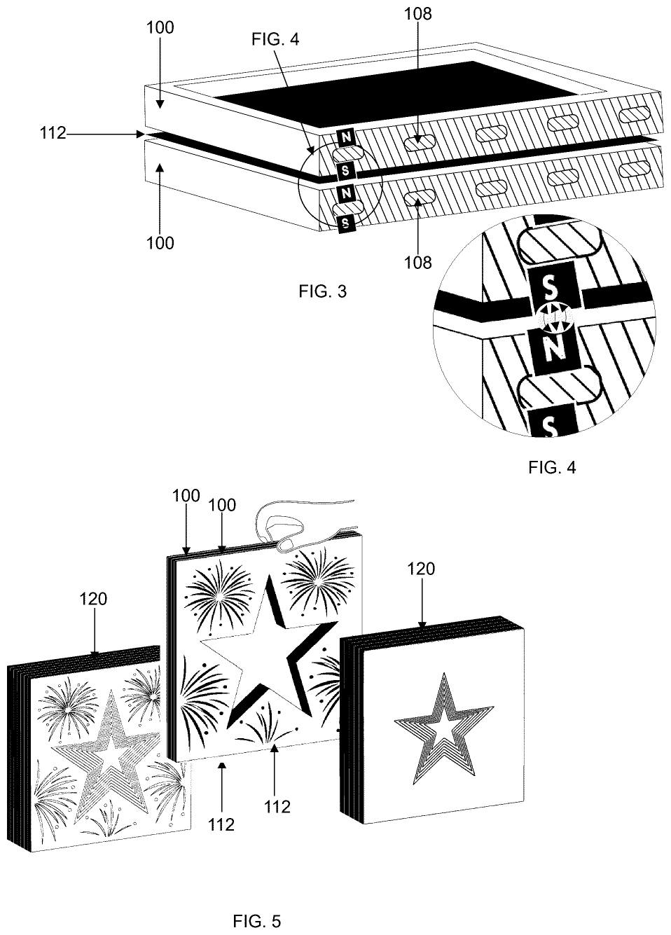

FIG. 3—Exploded Side View of Two Magnetic Spacers with Polarized Magnets and Intervening Art Layer

FIG. 3 shows an exploded side view of two magnetic spacers (100), separated by an intermediate artwork layer (112). Each spacer includes a plurality of embedded magnets (108), labeled with both “N” (north) and “S” (south) polarities to indicate their magnetic orientation. The magnets are arranged so that the S-pole of each magnet in the upper spacer faces the N-pole of the corresponding magnet in the lower spacer. This deliberate polarity alignment ensures consistent magnetic attraction between the spacers, allowing them to securely attach to one another when stacked. This configuration eliminates the need for adhesives or mechanical fasteners while maintaining precise, repeatable positioning during assembly.

### FIG. 4—Enlarged Detail View Showing Magnetic Polarity Alignment Between Spacer Magnets

FIG. 4 provides a magnified detail view of the aligned embedded magnets (108) from FIG. 3. Each magnet is labeled with its respective polarity—“N” for north and “S” for south—to demonstrate how opposing poles face each other across adjacent magnetic spacers (100). This intentional arrangement ensures secure magnetic attraction between layers without the need for adhesives or mechanical fasteners. The enlarged view further clarifies the internal behavior of the system's magnetic functionality, as described in Claim 3.

FIG. 5—Perspective View Illustrating Non-Destructive Removal of Magnetic Spacers and Artwork Layers from a Magnetic Spacer System

FIG. 5 depicts a perspective view of a magnetic spacer system (120) configured with multiple artwork layers (112) and magnetic spacers (100). Two magnetic spacers (100) and two corresponding artwork layers (112) are shown removed from the original system. This figure illustrates that such removal can occur cleanly and without damage, due to the absence of adhesives or permanent fasteners. The resulting magnetic spacer system (120), now with fewer layers, remains complete and functional, and the removed components remain intact and ready for reassembly or modification. This configuration supports the invention's intended use as a modular, reconfigurable system that allows for non-destructive separation and rearrangement of components.

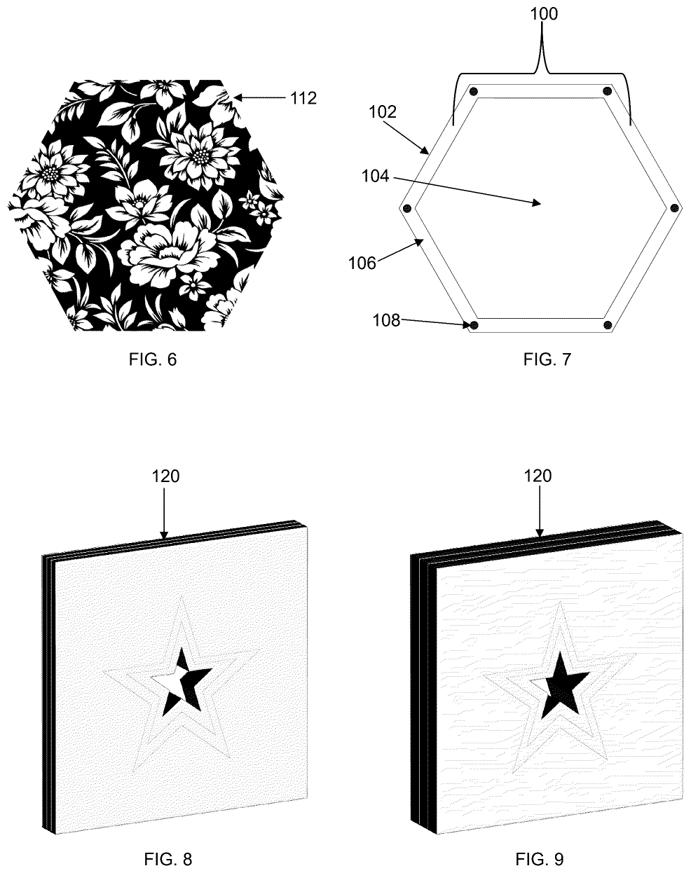

### FIG. 6—Top View of a Custom-Shaped Artwork Layer

FIG. 6 illustrates a custom-shaped artwork layer (112) with a decorative hexagonal outline. This figure is provided to demonstrate that the invention supports non-standard or personalized shapes. The artwork layer shown here is intended for use with a correspondingly shaped magnetic spacer, as depicted in FIG. 7. The ability to match custom outlines is a core feature of the magnetic spacer system, as stated in Claim 5.

### FIG. 7—Top View of a Magnetic Spacer Cut to Match a Custom Artwork Shape

FIG. 7 shows a magnetic spacer (100) manufactured in a custom hexagonal shape to match the artwork layer shown in FIG. 6. The spacer includes an outer contour (102) that defines the external boundary and mirrors the custom shape of the corresponding artwork layer. A central cutout (104), scaled down from the outer contour, allows visibility through the layered composition. The material between the outer contour and the cutout forms the spacer body (106), which houses a plurality of embedded magnets (108). These magnets are enclosed within the spacer body and positioned to align with magnets in adjacent spacers. This figure demonstrates that the spacer can be tailored to match unique shapes, supporting both standard and custom outlines, as described in Claim 5.

FIG. 8—Perspective View of a Magnetic Spacer System with Reduced Spacer Thickness

FIG. 8 illustrates a magnetic spacer system (120) comprising alternating magnetic spacers and artwork layers, shown in a slightly tilted front view to convey dimensionality. In this configuration, the magnetic spacers are thinner, resulting in less depth between layers and a flatter overall profile. The number of layers is consistent with that shown in FIG. 9, allowing for a direct comparison of the effects of spacer thickness. This figure supports Claim 6 by demonstrating how selecting thinner spacers reduces the depth of the layered artwork composition.

FIG. 9—Perspective View of a Magnetic Spacer System with Increased Spacer Thickness

FIG. 9 depicts a magnetic spacer system (120) composed of the same number of artwork layers and magnetic spacers as shown in FIG. 8, but with increased spacer thickness. The perspective view highlights the enhanced depth and dimensionality achieved by using thicker spacers. This visual comparison reinforces Claim 6 by showing how the invention allows users to select spacer thickness based on desired visual effect, enabling greater customization in three-dimensional layered artwork assemblies.

The magnetic spacers are designed such that the embedded magnets (108) exert a magnetic attraction strong enough to securely hold adjacent spacers (100) in position and support intermediate artwork layers (112) without sagging. This strength ensures stable alignment of stacked layers, even without the use of adhesives or fasteners. Each spacer is constructed from a material that is lightweight and shape-retaining, such as corkboard, rubber, or foam. These materials are selected for their ease of cutting and shaping, as well as for their ability to maintain consistent spacing between layers of artwork materials such as paper, cardstock, vinyl, thin acrylic sheets, or comparable substrates. These materials resist deformation under normal handling and display conditions, allowing the system (120) to maintain uniform depth across multiple layers.

In addition to the structural features illustrated in the preceding figures and paragraph, the magnetic spacer system is well-suited for a variety of display applications. These include shadow box displays, layered paper craft projects, illuminated art displays using LED light bases, and standalone three-dimensional artwork presentations. The system's modular construction, adhesive-free design, and customizable shape compatibility allow it to adapt to a wide range of artistic and display contexts. The layered effect produced by the magnetic spacers can be enhanced by lighting or shadow depth, depending on the final use case.

### Use and Assembly

In practice, the user begins by placing a first artwork layer (112) on a flat surface. A magnetic spacer (100) is then aligned over the artwork layer, with its outer contour matching the shape of the artwork. A second artwork layer (112) is placed on top of the spacer, followed by another magnetic spacer (100). This layering process is repeated, alternating artwork layers and magnetic spacers. Each spacer magnetically attaches to the one below it, securing the artwork layers in position without adhesives. The spacer, with embedded magnets, maintains uniform spacing between layers, prevents sagging, and allows for easy, tool-free assembly and disassembly.

### Best Mode and Materials

In the best mode currently contemplated by the inventor, each magnetic spacer (100) is formed from a lightweight, shape-retaining material such as corkboard, rubber, or foam. The spacer body (106) includes a plurality of fully embedded magnets (108), which are positioned to ensure proper alignment and secure magnetic attachment between adjacent spacers (100). The selected materials maintain consistent spacing between artwork layers, prevent sagging, and support clean visual layering without adhesives or fasteners. This configuration reflects the inventor's preferred approach for achieving durable, reusable, and aesthetically precise layered artwork assemblies.

### Alternative Embodiments

In other embodiments, the magnetic spacer (100) may be manufactured in standard or custom shapes that correspond to the outline of the user's artwork. The central cutout (104) may be scaled proportionally to create varying levels of visibility or visual depth between layers. Spacer thickness may also vary to achieve a desired three-dimensional appearance or fit within different types of display enclosures. The number and placement of embedded magnets may differ depending on the size of the artwork and the strength of the magnets used, allowing for reliable alignment and support across a range of configurations.

1. A magnetic spacer system for maintaining space between layers of artwork, comprising:
a set of spacers, each spacer composed of a flexible and shape-retaining material selected from the group consisting of corkboard, rubber, or foam;
wherein each spacer has an outer contour and a central cutout that are the same shape, with the cutout being a scaled-down version of the outer contour, such that the spacer defines a continuous border of material between the two shapes;
wherein each spacer includes a plurality of embedded magnets;
wherein the magnets are positioned to align with adjacent spacers, allowing secure attachment without adhesives;
and wherein the system comprises at least three spacers to support and maintain uniform separation between at least two layers of art.

2. The system of claim 1, wherein the embedded magnets are fully enclosed within each spacer to prevent dislodgement during use.

3. The system of claim 1, wherein the magnets are polarized to ensure consistent magnetic attraction between adjacent spacers.

4. The system of claim 1, wherein each spacer is reusable and allows for non-destructive reconfiguration of the artwork layers.

5. The system of claim 1, wherein each spacer is manufactured in a shape that matches a custom or standard outline of the art layer it supports.

6. The system of claim 1, wherein the thickness of each spacer is selected to produce a desired depth between art layers.

7. The system of claim 1, wherein the system is suitable for use in shadow box displays, layered paper crafts, illuminated art displays, or as a standalone layered artwork.

8. The system of claim 1, wherein each spacer contains fully embedded magnets that are concealed within the body of the spacer.

9. The system of claim 1, wherein the magnetic attraction strength between adjacent spacers is sufficient to support an intermediate artwork layer without sagging.

10. The system of claim 1, wherein each spacer is constructed from a material that is both lightweight and resistant to compression.

11. The system of claim 1, wherein the spacer material is selected to maintain consistent spacing between layers of artwork composed of paper, cardstock, vinyl, thin acrylic, or comparable flexible or semi-rigid materials, without compressing or sagging under normal handling conditions.

12. A method for assembling a three-dimensional layered artwork using magnetic spacers, comprising:
placing a first layer of artwork on a surface;
placing a first magnetic spacer over the first artwork layer, the spacer shaped to match the contour of the artwork;
placing a second layer of artwork over the first spacer;
placing a second magnetic spacer over the second artwork layer and magnetically attaching it to the first spacer;
repeating the steps of placing artwork layers and attaching magnetic spacers to create a stacked arrangement of alternating artwork layers and spacers;
wherein the magnetic spacers maintain uniform separation between the artwork layers without the use of adhesives.

13. The method of claim 12, further comprising repeating the spacer stacking and artwork layering steps to create additional dimensional layers.

14. The method of claim 12, wherein the magnetic spacers and artwork layers can be removed, replaced, or repositioned without damaging any components, due to the absence of adhesives or permanent attachment methods.

15. The method of claim 12, wherein the magnetic spacers are pre-cut to match a custom or standard artwork shape.

16. The method of claim 12, wherein the completed layered artwork is optionally placed within a shadow box, mounted on a display base, or displayed as a standalone piece.
